(19) United States
(12) Patent Application Publication
(10) Pub. No.: US 2005/0131613 A1
(43) Pub. Date: Jun. 16, 2005

(54) Method and device for controlling or regulating the brake system of a motor vehicle according to the "brake by wire" principle

(76) Inventors: Jurgen Bohm, Oberneisen (DE); Stefan Stolzl, Weinheim (DE); Rainer Oehler, Darmstadt (DE)

Correspondence Address: HONIGMAN MILLER SCHWARTZ AND COHN LLP, 32270 TELEGRAPH RD, SUITE 225, BINGHAM FARMS, MI, 48025-2457, US

(21) Appl. No.: 10/731,833

(22) Filed: Dec. 9, 2003

Related U.S. Application Data
(63) Continuation-in-part of application No. 09/601,590, filed on Oct. 24, 2000, now abandoned.

(51) Int. Cl. G06F 17/00; G06F 7/00

(52) U.S. Cl. 701/71

(57) ABSTRACT

The most important aspect of brake systems in motor vehicles functioning according to the brake-by-wire principle is that the driver's braking requirements are detected quickly and reliably. Fulfilling this requirement primarily depends on the pedal sensor system associated with the brake pedal and its measuring devices for determining the characteristic values of the brake pedal actuation. The present invention provides for at least two measuring devices for determining the braking requirement, with such measuring devices sensing the same characteristic value of the brake pedal actuation, e.g. the brake-pedal actuation force, brake-pedal travel or brake-pedal angle. These braking requirement signals are compared to a signal from a third measuring device in order to monitor the braking requirement measuring devices.

### RELATED APPLICATIONS

This application is a continuation-in-part of application Ser. No. 09/601,590, filed Feb. 3, 1999.

### TECHNICAL FIELD

The present invention generally relates to vehicle brakes, and more particularly relates to a method for controlling or regulating the brake system of a motor vehicle according to the brake-by-wire principle.

### BACKGROUND OF THE INVENTION

Normally brake systems for motor vehicles work according to the conventional principle of an hydraulic actuating device that is directly actuated by the brake pedal which is connected to the hydraulic wheel brakes. Similar to the principle of mechanically decoupling the control stick from the control rudders—known as the fly-by-wire principle—already applied in aircraft construction, designers of brake systems for motor vehicles also are trying to mechanically decouple the brake pedal from the brake system and introduce a brake-by-wire principle.

A brake system for motor vehicles working according to the brake-by-wire principle was disclosed in U.S. Pat. No. 5,230,549.

Brake systems of the brake-by-wire principle have a brake pedal that is decoupled mechanically from the brake system, which, however, is designed like a mechanically coupled brake pedal with respect to the way it is actuated due to corresponding mechanical means with reset mechanisms such as springs or similar elements. Thus, the driver actuates the brake pedal in the customary manner when he wants to brake. The brake pedal is equipped with sensor means with data conditioning, the so-called pedal module, which measures the actuation of the brake pedal—typically the foot actuating force exerted by the driver and/or the distance traveled by the brake pedal—in order to determine the so-called braking requirement of the driver. The signals of the driver's braking requirement are evaluated in a downstream central evaluation unit, which has at least -one microprocessor whose output signals are connected in particular to the brake modules on the wheels and the brake lights. The brake modules on the wheels typically exhibit their own control circuits for carrying out the brake actuation defined by the desired value of the braking requirement signal. However, the pedal module also can exhibit a microprocessor for conditioning data. The sensor data can also be connected directly to a computer bus; then the central computer or the wheel module computers generate the braking requirement.

A central issue with respect to these brake-by-wire systems is safety. Closely related to the issue of safety is that of fault detection and how the system acts in the event of a fault.

Since the braking action of the brake system depends on the braking requirements that were determined, no undesired braking action may occur when an error is made in detecting the braking requirement, in particular if a fault occurs in the pedal sensor system or the electronic unit itself. Measures for detecting faults or controlling the brake system in the event of an error are not described in U.S. Pat. No. 5,230,549.

DE 195 10 525 A1 (=EP 08 149 81 A 1) disclosed measures which improve the performance of brake systems of the brake-by-wire type with respect to possible fault states in connection with determining the braking requirements. The central measure is to have the driver's braking requirement determined by at least two independent measuring devices, which determine different characteristic values of the brake pedal actuation on the basis of different measuring principles (diversity). The values of the braking requirement determined in this way are then compared, and if there are impermissible deviations a fault state is recognized.

Even if certain faults can be detected with these known measures, which are based on diversity, the number of recognizable types of faults is still limited, as is the speed with which faults are detected. Thus, the system disclosed calls for a sophisticated and complex design in order to be able to differentiate mechanical faults in the brake pedal module from faults in the sensor system, and no unequivocal information on localizing the faults can be obtained. In the worst case this can lead to an inconsistent state and total failure of the brake system.

The object of the present invention is to control the above-mentioned method and/or to design the above-mentioned device in such a way that the braking requirements can be determined quickly with a monitoring function, which covers and detects quicker more faults than other hitherto disclosed methods.

This object is achieved by the method according to the invention in that the measuring devices determine the same characteristic value of the brake pedal actuation for determining the braking requirement and another measured value is derived for monitoring the mechanical pedal means and pedal sensor system and compared to the braking requirement signal in the electronic evaluation unit.

With respect to the device for controlling or regulating the brake system of a motor vehicle according to the brake-by-wire principle, comprising a brake pedal with mechanical pedal means and a pedal sensor system, at least one electronic evaluation unit and wheel brake modules as well as
a pedal sensing unit for sensing when the driver actuates the brake pedal, with said pedal sensing unit being composed of at least two measuring devices that sense the characteristic values of the brake pedal actuation, and
an evaluation unit that determines the driver's braking requirements based on the signals of the measuring devices,
   the object of the present invention is achieved by designing the measuring devices in such a way that they determine the same characteristic value of the brake pedal actuation for determining the braking requirements on the basis of the evaluation unit and that another measuring device is provided for monitoring the mechanical pedal means and pedal sensor system, the measured signals of which are compared to the braking requirement signal in the evaluation unit.

The braking requirement can be determined quickly by the measure according to the present invention, including a monitoring function that covers and recognizes quicker more types of faults than any known methods. Thus, safety, reliability and availability are improved. Since the braking requirement is determined on the basis of a physical variable (e.g. the pedal actuation force) by means of two sensors, only minimal monitoring of the pedal module is necessary.

These advantages are particularly evident when both measuring devices are made up by identical sensors in a further embodiment of the invention.

Preferably the two measuring devices used for determining the braking requirement sense the force of the driver's foot, expressed by the pedal actuation force. The force of the driver's foot is determined preferably only when the fault jammed pedal is to be detected by the evaluation electronic unit. If, due to an intelligent design, this fault case has a failure probability smaller than the failure probability of the sensor system, the evaluation electronics or the fault breaking pedal, then also two distance or angle sensors or alternatively one distance and one angle sensor can be used for determining the braking requirement.

The other monitoring measuring device preferably measures the brake pedal travel s or the brake pedal angle á and does not need to determine the force F. The force F as a monitoring value needs to be determined only for reasons of comfort, since it is accompanied by certain disadvantages typical of the system.

### BRIEF DESCRIPTION OF THE DRAWINGS

FIG. 1 shows a block diagram of a control or regulating system of a brake system in a motor vehicle according to the brake-by-wire principle, including the pedal sensors designed according to the present invention.

FIG. 2 is a flow diagram of the basic calculation of the braking requirement, brake force and fault localization according to a first embodiment.

FIG. 2A shows a variant of the flow diagram according to FIG. 2, where the gradient of the sensor signals is included in the calculation.

FIG. 2B shows an alternative to FIG. 2 regarding the formation of the braking requirement signal for determining the braking requirement when the sensors are defective.

FIG. 2C supplements FIG. 2 and includes a third sensor signal for detecting a fault in the monitoring sensor.

FIG. 3 is a flow diagram of the basic calculation of the braking requirement, brake force and fault localization according to a second possibility, including calculating the gradients of the sensor signals.

FIG. 3A is an alternative similar to FIG. 2B regarding the selection of the sensor signal for forming the braking requirement in case of a defect in one of the braking requirement sensors.

FIG. 3B supplements the flow diagram according to FIG. 3 analogously to FIG. 2C with respect to including a third signal for detecting a fault in the monitoring sensor.

FIG. 4 is a flow diagram of extended signal processing with status reports, including the calculation of the total brake force.

### DETAILED DESCRIPTION OF THE PREFERRED EMBODIMENTS

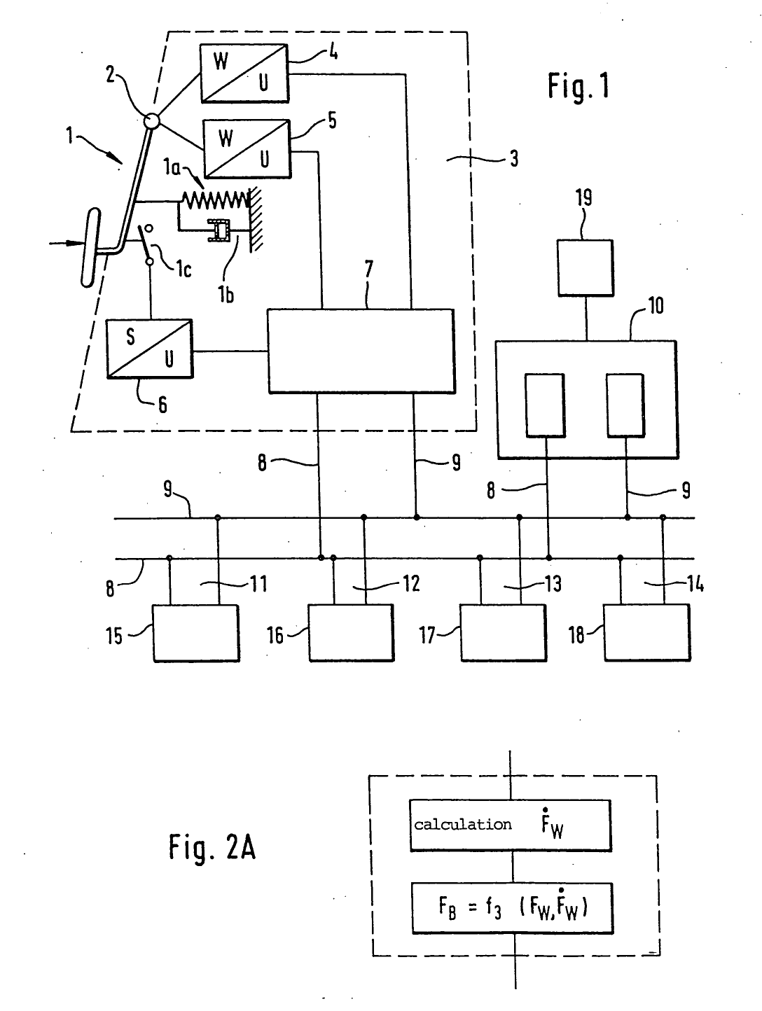

In a block diagram FIG. 1 shows the basic structure of a brake system according to the brake-by-wire principle. First the brake system exhibits a brake pedal 1 with a coupling having known mechanical pedal means, which reproduces the behavior of a conventional brake pedal that is connected mechanically to the brake system. These mechanical pedal means can be a mechanical element with a reset mechanism, e.g. a spring 1a. Reproduced hydraulic or pneumatic arrangements 1b are feasible, too. Characteristic of the pedal actuation is the foot force exerted by the driver, which is expressed in a corresponding pedal actuation force and/or the foot travel that is reflected in a corresponding brake pedal travel S or in a brake pedal angle W. These reproduced arrangements 1a, 1b can be provided once or can be provided in double form so as to increase the safety (redundancy). The characteristic values S or W for the pedal motion are sensed by a pedal module 3, which exhibits three measuring devices 4, 5, 6 with appropriate sensors and a device for conditioning the measured data 7 in the embodiment shown. At the output of pedal module 3 the conditioned sensor signals or the braking requirement F_{w} calculated on the basis of these signals are made available on the data connections 8, 9, which are provided two times for reasons of safety, if the device for conditioning the measured data 7 contains a computer. In the first case, the sensor signals generated through the actuation of the pedal and conditioned are transmitted via the connections 8,9 to an evaluation unit 10, which typically is a computing system with two computers 10a, b. The computing system determines the driver's braking requirement Fw on the basis of the conditioned sensor signals. This braking requirement is a measure for the desired braking effect of the brake system, and in the preferred embodiment it represents the brake force. In addition to the brake force, other values, e.g. values representing the braking torque, braking pressure, vehicle deceleration, braking power etc., can be calculated in the conditioning device 7 on the basis of the sensor signals and provided to the evaluation unit 10.

The evaluation unit 10 converts the determined braking requirement to desired values for the wheel brakes, taking into consideration the desired brake force distribution, brake-pad wear, axle loads etc. In the preferred embodiment these desired values represent the brake force to be set at the wheel brakes; in other advantageous embodiments they represent the brake force that is to be set, the braking torque that is to be set, etc. In the preferred embodiment taken as an example, the evaluation unit 10 sends individual desired values or control values for setting these desired values to the wheel brake modules 15, 16, 17 and 18 via the redundant lines 11, 12, 13, 14, with the wheel brake modules themselves containing computers, so that the braking requirement can be determined from the sensor signals even if the central computer 10 should break down.

Furthermore, a display or alarm device 19 is connected to the evaluation unit 10, which notifies the driver of faults in the brake system.

The arrangement according to FIG. 1 is a special embodiment. It would also be feasible to combine the step of conditioning the measured-data 7 with the electronic evaluation step 10.

The measuring devices 4, 5 and 6 are of special importance with regard to the operational reliability of the brake system because they sense any actuation of the brake pedal. According to the present invention, two measuring devices 4 and 5 of the same kind are provided; they determine identical characteristic values of the brake-pedal actuation and preferably also exhibit identical sensors. Preferably both measuring devices sense a value characterizing the driver's foot force, e.g. the brake-pedal force. In another embodiment, an angle of rotation can be measured two times. This is of particular importance in connection with brake pedals that include a rotational movement when they are actuated. In pedals moved translatorially the pedal path s is determined.

Based on the signals of the measuring devices 4 and 5, the braking requirement, i.e. a characteristic value of the brake effect, e.g. in the form of a total brake force to be applied, is calculated for the vehicle either in the step where the measured data is conditioned 7 or in the central computer 10 and, as already shown, forwarded for controlling the electric brake system of the motor vehicle.

A third value is sensed by the measuring device 6; it is used for controlling the mechanical pedal means and pedal sensor system of the brake-pedal module 3 and preferably senses a different physical value than that sensed by the two braking requirement sensors 4 and 5 when the driver actuates the brake pedal. This third measuring device 6 basically is a monitoring sensor; if, for example, the measuring devices 4 and 5 determine the brake-pedal force, the measuring device 6 can sense the brake-pedal travel by means of a position sensor, e.g. through a digital angle sensor integrated in the coupling 2 of the brake pedal. The position sensor then outputs coded signals representing the respective position or, as shown in FIG. 1, position pickup 1c. In addition, the third sensor may be a force sensor that senses the brake-pedal force.

Through these measures the safety, reliability and availability of the brake system are increased. By sensing the braking requirements through an identical physical value, e.g. the driver's foot force, or the pedal angle with two identical sensors, the scope of monitoring of the pedal module can be minimized when the sensor means are selected appropriately. In the arrangement according to the present invention, the complexity of differentiating between mechanical faults and sensor faults has been reduced and unequivocal information on the localization of the fault can be obtained, so that no inconsistent states or a total failure of the brake system can occur.

The reduced complexity of detecting and localizing faults as compared to known principles becomes evident in connection with the following considerations. If, for example, measuring devices 4 and 5 are formed by two force or angle sensors, changes in the mechanical pedal means are not important at first since they are not accompanied by a deviation from the measured values. As long as the mechanical means are in order both sensors will deliver the same signal, if the mechanical means are defective both sensors also will deliver a corresponding identical signal. Thus, in the simplest case, the mechanical means need not be monitored with this kind of sensor arrangement, if one does not take into consideration the unlikely case of the pedal breaking.

Additional advantages of the invention are as follows:

In addition to sensor and electronic faults or failures, faults or failures in the mechanical means have to be taken into account with respect to monitoring and detecting faults of the pedal modules. In particular, for example, a jammed pedal must not affect the calculation of the braking requirement. A jammed pedal may have two consequences: The driver can hardly move the pedal forward or cannot move it all when he wants to actuate the brakes (it may already have been pushed forwards partially) or the pedal does not return to its initial position when the actuation is terminated or it does not return there quickly enough.

When a displacement sensor or a sensor for angles of rotation is used in measuring device 6, a displacement or angle of rotation is still shown, however, even if the driver does not actuate the pedal anymore. This means that the nominally fundamental connection between pedal travel and force is no longer given in this fault situation. Thus, incorrect conclusions may be drawn in connection with localizing the fault and calculating the braking requirement, which may lead to inconsistent behavior of the system. In the worst case, a properly working sensor would no longer be taken into consideration by the system due to a majority decision, whereas a defective sensor is not recognized as such. This can lead to a total failure of the brake system since no meaningful desired brake value can be generated anymore.

For this reason two force sensors or torque sensors are preferably used in electromechanical brake systems so as to still be able to generate an unequivocal braking requirement in the mechanical actuation means and to ensure unequivocal monitoring, i.e. to be able to differentiate between a jammed and not jammed pedal. In electrohydraulic or electropneumatic pedal modules, preferably two pressure sensors or also two sensors for angles of rotation are suitable. However, a reciprocal arrangement of sensors also is meaningful, for example two sensors for angles of rotation and one force sensor.

Faults in the two braking requirement sensors 4, 5 can be detected quickly by simply comparing the signals or measured values. Preferably it is checked whether both values lie within a specified tolerance range.

A calculation of the braking requirement is sufficient at first if it is carried out on the basis of only one measured value from the two braking requirement sensors 5, 6. The second braking requirement sensor then is used only for monitoring and confirming the first braking requirement sensor. For this reason, the second braking requirement sensor may exhibit less accuracy and resolution and, hence, be a more cost-efficient variant than the first braking requirement sensor.

If the two braking requirement sensors 4, 5 exhibit an impermissible deviation from the measured values, the monitoring sensor is used to localize the defective sensor through a majority decision, for example by first comparing the measured value of the first braking requirement sensor to the measured value of the monitoring sensor. If both lie within a specified tolerance, the second braking requirement sensor is taken to be defective. If not, then it is the first braking requirement sensor.

Alternatively, the deviations are determined by both braking requirement sensors 4, 5 as well as the monitoring sensor 6 and compared to one another. The braking requirement sensor whose value deviates greater from the monitoring sensor will be considered to be defective.

Alternatively the desired braking values are calculated by all three sensors 4, 5, 6 and compared to one another (always one braking requirement sensor to the monitoring sensor respectively). The braking requirement sensor whose braking requirement value deviates greater from the monitoring sensor will be considered to be defective.

If the monitoring sensor 6 is used for localizing a fault in sensor 4 or sensor 5, it must be ensured in advance that the monitoring sensor provides an error-free sensor value. For this purpose—if the comparison between sensor 4 and sensor 5 shows no error—the braking requirement calculated from sensor 4 or sensor 5 or both sensors must be compared to the braking requirement calculated from the signal of the monitoring sensor 6. In this connection it is assumed that no double errors occur during operation (except when there is a power failure), i.e. a braking requirement sensor and the monitoring sensor or both braking requirement sensors will not exhibit an error simultaneously and independently of one another. If there is no significant deviation, the monitoring sensor 6 can be used to localize the error. If there is an error, then either the monitoring sensor or the mechanical fault means is defective. In this case, sensor 6 is deactivated since this has the same effect on both types of faults.

Generating a braking requirement, monitoring and localizing faults based on two force sensors acting as braking requirement sensors 4, 5 and a sensor 6 (e.g. position sensor) for monitoring purposes is insensitive towards mechanical changes in the pedal (e.g. damping, hysteresis, foot-force/foot travel characteristic curves). In the event of mechanical changes, the driver himself can balance out these changes by adapting his foot force or foot travel to the changes in the mechanical means. It is important, however, that the pedal module can calculate a desired braking value corresponding to the driver's braking requirement over as long a period as possible. This is realized with the two braking requirement sensors that measure the same type of variable (e.g. force or torque or travel). Also in connection with changes in the mechanical means (jammed/not jammed pedal) a braking requirement can be generated immediately, since both sensors will not show any deviations when both are working properly. If, as in cases known, a force sensor and a position sensor are used as braking requirement sensors, then the desired braking values could not be calculated immediately when there are changes in the mechanical means since it would first have to be determined whether the sensor means or the mechanical means are defective. This renders the system unnecessarily complex and, hence, more prone to errors.

The sensors measuring the characteristic values of the driver's foot force and the monitoring sensor, provided it measures the same value, preferably are arranged in brake pedal 1. Thus, the braking requirement can be determined unequivocally from the sensors even if the mechanical pedal means fail (e.g. jammed pedal). Then it is not necessary to differentiate between (error localization) sensor error and mechanical errors, since mechanical errors do not affect the sensor signals, except when the pedal breaks.

It can be assumed that the driver is in a position to recognize any changes in the mechanical means that may be uncomfortable for him and to have them repaired appropriately. Hence, it is not absolutely necessary to monitor the mechanical means.

If the two braking requirement sensors 4, 5 used have the same accuracy, the monitoring sensor 6 may exhibit a lower accuracy, since it is used only for localizing errors.

If, however, two braking requirement sensors 4, 5 with different accuracy are used, preferably a sensor 6 with an accuracy corresponding to the better of the two braking requirement sensors is used.

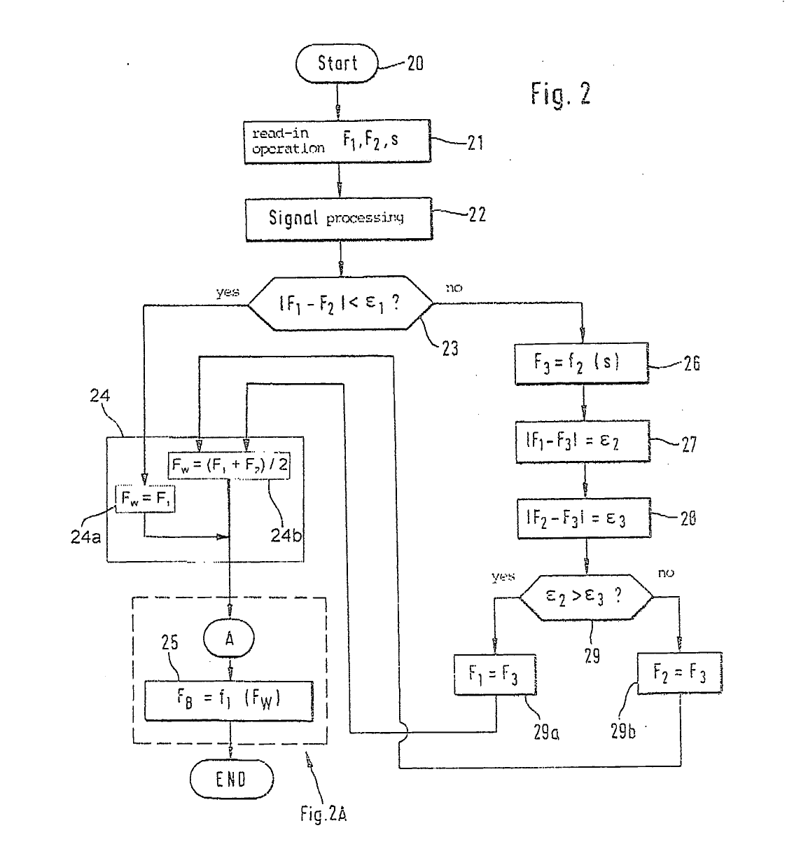

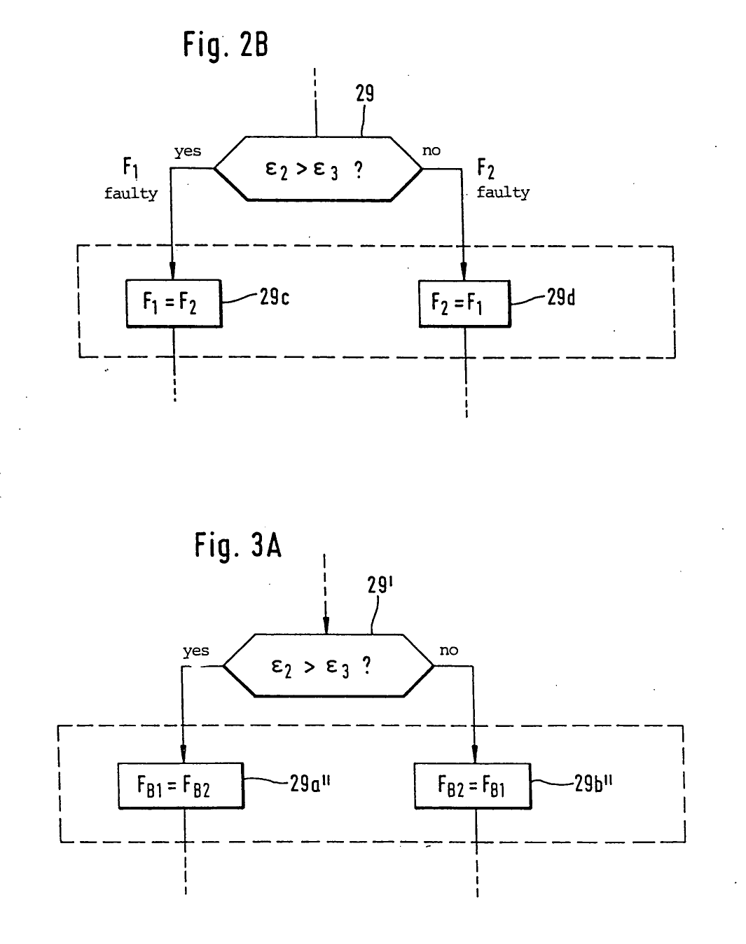

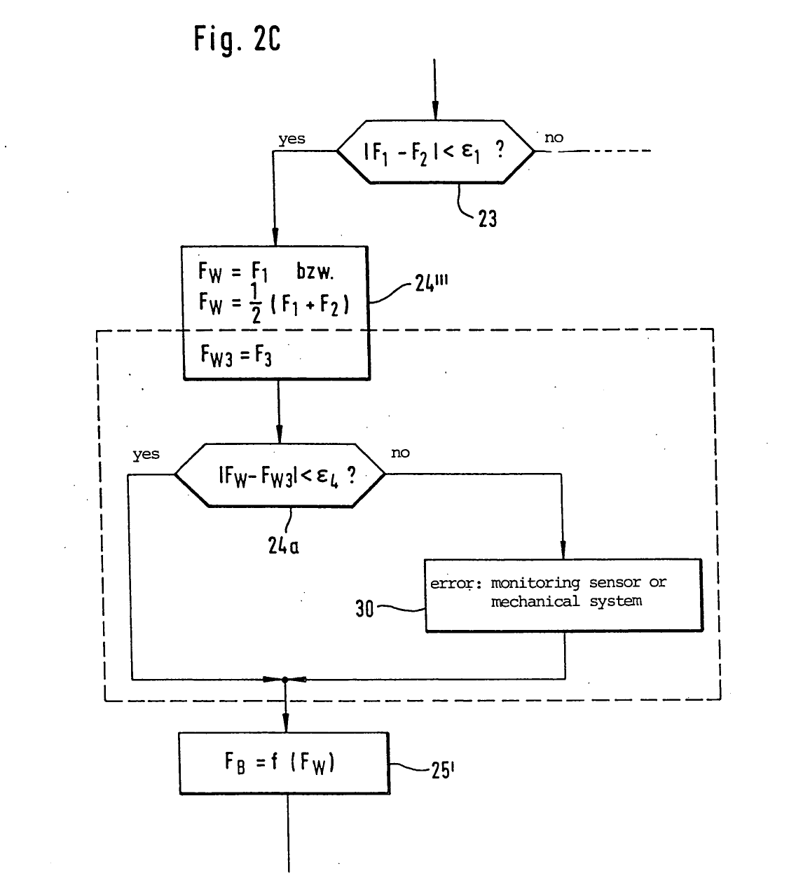

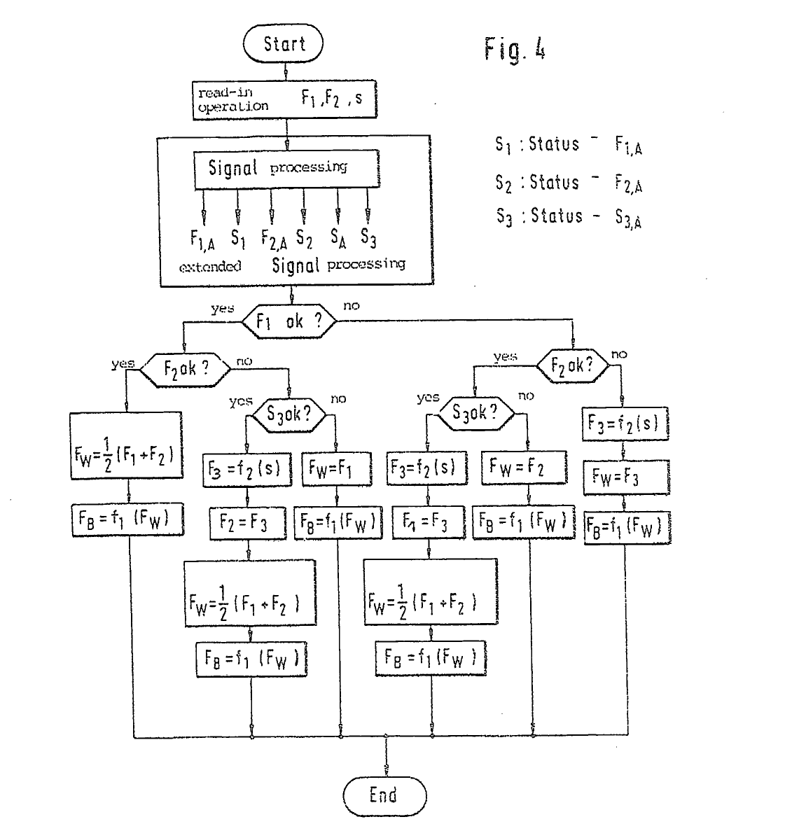

FIGS. 2 and 4 as well as other sub-figures show flow diagrams for detecting faults and calculating the braking requirement and the braking force according to the above considerations.

In the flow diagrams, F1 refers to the first braking requirement sensor value of measuring device 4 (e.g. force 1) and F2 refers to the second braking requirement sensor value of measuring device 5 (e.g. force 2). The monitoring value (e.g. travel) of the third measuring device 6 is described by s. Specified limits are defined by ε. F_{B} refers to the total braking force for the whole motor vehicle and is taken as the basis for distributing the braking force among the individual wheel brake modules.

Functions f1, f2 etc. are functional relationships used for determining the braking forces from the sensor signals or the driver's braking requirement F_{w}. In the simplest case, there is a linear relationship between the input and output value in the functions f1, f2 etc.

F_{w} refers to the driver's braking requirement as determined from the sensor signals.

FIG. 2 shows the basic calculation of the braking requirement and the error localization according to a first possibility. After starting 20 of the program part shown in FIG. 2, the signals F1, F2 of measuring devices 4 and 5 (FIG. 1) as well as the signal s of measuring device 6 are read-in in the first step 21. In step 22 the signals are processed to make them comparable in the subsequent steps. In step 23, which is a decision step, the difference between signals F1 and F2 is compared with a first barrier. If the difference is smaller than the specified first barrier, i.e. if there are no errors, then—via the Yes-output—the braking requirement F_{w} is determined in step 24 by means of the equation F_{w}-F1 (step 24a) and the total braking force F_{B} in step 25.

If, however, program step 23 shows that the difference is greater than the first barrier, i.e. one of the sensors of measuring devices 4, 5 is defective, then the signal F3, which is a function of pedal travel s, is taken as a decision aid in step 26 by comparing this signal in steps 27 and 28 to the values F1 and F2 respectively, i.e. with the output signals of the measuring devices 4 and 5. Depending on which difference is greater, i.e. whether F1 or F2 is defective, which is determined in step 29, either F1 or F2 of the measuring devices 4 or 5 is taken as the basis for calculating the braking requirement of the driver in program step 24. This is done I nstep 24b by calculating the braking requirement of the driver F_{w} as an arithmetic mean value of F1 and F2. Program steps 26 to 29 ensure that, even though there is an error in one of the two measuring devices 4 or 5, the intact value is used for determining the braking requirement by means of a comparison with monitoring sensor 6.

Block 25 in FIG. 2 can be replaced by the block shown in FIG. 2A if the gradients of the sensor signals for calculating a dynamic braking requirement F_{w} are also determined, i.e. according to the block in FIG. 2A, the gradient calculation of the sensor signals is included. Thus, dynamic changes in the signals can be taken into account. In particular when the driver actuates the brakes out of panic, a strong rise in the gradient can also be used for supporting or increasing the braking force of the motor vehicle and it helps the driver by providing shorter or optimal braking distances.

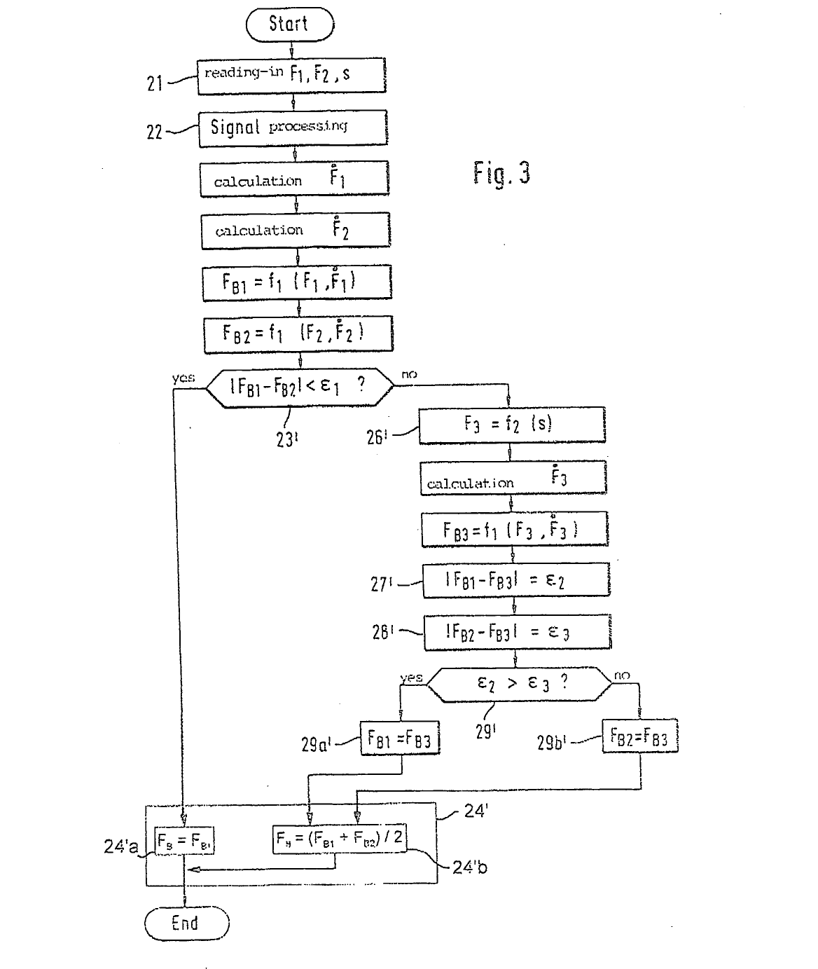

FIG. 3 shows another flow diagram for the basic calculation of the braking requirement, braking force and error localization according to a second possibility, where the gradient calculation of the sensor signals is included continuously. For this purpose the gradient is determined by forming the difference between the current measured value and the measured value of the previous program run. How the braking force F_{B} is calculated in connection with the individual observation of errors is shown in the flow diagram or in connection with the description of FIG. 2 (identical boxes have the same reference number).

Alternatively to using the monitoring sensor 6 and the signal F3 for determining the braking requirement in the event of a fault in the sensors 4 (F1) or 5 (F2), i.e. does the decision in program step 23 lead to a No, only the braking requirement sensor that is still intact can be used, i.e. either F1 or F2. The corresponding alternative representation of the sequence of program steps 29, 29a and 29b in FIG. 2 is shown in FIG. 2b, whereas the alternative sequence for the possibility according to FIG. 3 is shown in FIG. 3A.

If monitoring sensor 6 is used and it measures the same physical value as the braking requirement sensors 4 and 5, calculating the comparison value F3 or F_{B3} (FIGS. 2 and 3) needed for detecting an error is simplified. Therefore, the comparison with the braking requirement signals F1, F2 is more reliable or can be made with smaller thresholds ε2 and ε3.

FIG. 2C supplements the flow diagram according to FIG. 2 by step 24 for determining the braking requirement F_{w}; however, in the newly formed program step 24′″ the braking requirement calculated from sensor 4 (F1) or sensor 5 (F2) or both is compared with the braking requirement calculated from the monitoring sensor (F3). If, according to decision step 24a′, the comparison results in a difference that is greater than threshold ε4, then either the monitoring sensor or the mechanical pedal means is defective. Reference is also made to the explanations regarding advantage number 5.

A corresponding supplement of the flow diagram for the possibility shown in FIG. 3 is shown in FIG. 3C. This requires no additional explanations in view of the detailed description provided for FIG. 2C.

When a fault occurs in the monitoring sensor 6, a corresponding error display may occur in step 30, e.g. through a yellow light, or the fault can be saved in an error memory. If a deviation between sensors 4 and 5 then occurs as another fault, the fault cannot be localized anymore. In order to be able to calculate the braking requirement anyway, it would be meaningful to calculate the braking requirement from both sensors, i.e. by taking the mean value. Thus it would be ensured that a more or less correct braking requirement will be calculated, i.e. it will be possible to brake the motor vehicle, irrespective of the fault, even if the scaling and offset are changed.

Another supplement is that the status messages of all sensors are co-determined in the preliminary signal processing. Preferably levels, error counters, outliers and signal deviations will be determined. The result includes both a sensor value and a status which indicates whether the corresponding sensor is working properly (ok) or not. FIG. 4 shows the flow diagram for calculating the braking requirement, brake force and error localization when status messages can be used via the sensor signals. This flow diagram is self-explanatory due to the text provided in the operating/decision boxes.

If two sensors no longer receive any power when there is a power supply failure despite a redundant power supply, then only the sensor that receives power from the intact second power supply can be evaluated. In this case, no error detection will be executed anymore for the sensors that are without power, and only the remaining sensor will be evaluated. For this reason a status message regarding the state of the power supply has to be included in the braking requirement calculation.

The brake lights preferably are activated by the sensor signal used for calculating the braking requirement or brake force, so that the brake lights can still be activated even when a sensor is defective. This is particularly important in such cases where the activation of the brake lights depends on one single sensor, which could break down, even though the motor vehicle can still be braked due to the error-tolerant sensor system of the pedal.

1. A method for controlling the brake system of a motor vehicle, said brake system of the type including a brake pedal, a pedal sensor system, an electronic evaluation unit and wheel brake modules, the method comprising the steps of:
generating a first signal representative of a first braking requirement based on a first physical value measured by a first measuring device,
generating a second signal representative of a second braking requirement based on a second physical value measured by a second measuring device, the second physical value being identical to the first physical value,
generating a third signal representative of a monitoring value measured by a third measuring device that monitors the brake pedal and the pedal sensor system, the monitoring value being different than the first and second physical values,
determining a first difference between the first and second signals,
wherein the driver's braking requirement is determined based on an average of the first and second signals when the first difference between the first and second signals is greater than a first predetermined value, and
wherein the first signal is equal to the third signal when a second difference between the first and third signals is greater than a third difference between the second and third signals, and
wherein the second signal is equal to the third signal when the third difference between the second and third signals is greater than the second difference between the first and third signals.

2. A method according to claim 1, wherein the first and second physical values are a driver's foot force.

3. A method according to claim 2, wherein a pedal actuation force is sensed to determine the driver's foot force.

4. A method according to claim 1, wherein the third physical value is an angle of adjustment of the brake pedal.

5. A method according to claim 1, wherein the third physical value is a pedal travel of the brake pedal.

6. A method according to claim 1, wherein gradients of the first, second and third signals are used to determine the driver's braking requirement.

7. A device for controlling the brake system of a motor vehicle, comprising:
a pedal sensor system including a pedal sensing unit for sensing when the driver actuates a brake pedal, wherein said pedal sensing unit comprises:
a first measuring device for generating a first signal representative of a first braking requirement based on a first characteristic value,
a second measuring device for generating a second signal representative of a second braking requirement based on a second characteristic value, the second characteristic value measured by the second measuring device being identical to the first characteristic value measured by the first measuring device,
a third measuring device that monitors the brake pedal and the pedal sensor system for generating a third signal representative of a monitoring value, the monitoring value being different than the first and second characteristic values, and
an electronic evaluation unit for determining a first difference between the first and second signals,
wherein the driver's braking requirement is determined based on an average of the first and second signals when the first difference between the first and second signals is greater than a first predetermined value, and
wherein the first signal being equal to the third signal when a second difference between the first and third signals is greater than a third difference between the second and third signals, and
wherein the second signal being equal to the third signal when the third difference between the second and third signals is greater than the second difference between the first and third signals.

8. A device according to claim 7, wherein the first and second measuring devices include sensors for sensing a driver's foot activation force.

9. A device according to claim 7, wherein the first and second measuring devices include sensors for sensing one of a pedal travel and a pedal angle.

10. A method for controlling the brake system of a motor vehicle, said brake system of the type including a brake pedal, a pedal sensor system, an electronic evaluation unit and wheel brake modules, the method comprising the steps of:
generating a first signal representative of a first braking requirement based on a first physical value measured by a first measuring device,
generating a second signal representative of a second braking requirement based on a second physical value measured by a second measuring device, the second physical value being identical to the first physical value,
generating a third signal representative of a monitoring value measured by a third measuring device that monitors the brake pedal and the pedal sensor system, the monitoring value being different than the first and second physical values,
determining whether one of the first, second and third measuring devices are defective,
wherein the driver's braking requirement is determined based on an average of the first and second signals, the second signal being set equal to the third signal when the first and third measuring devices are operable and the second measuring device is defective, and
wherein the driver's braking requirement is determined based on the first signal when the first measuring device is operable and the second and third measuring devices are defective, and
wherein the driver's braking requirement is determined based on an average of the first and second signals, the second signal being set equal to the third signal when the second and third measuring devices are operable and the first measuring device is defective, and
wherein the driver's braking requirement is determined based on the second signal when the second measuring device is operable and the first and third measuring devices are defective, and
wherein the driver's braking requirement is determined based on the third signal when the third measuring device is operable and the first and second measuring devices are defective.
